(19) United States
(12) Patent Application Publication
(10) Pub. No.: US 2007/0076971 A1
(43) Pub. Date: Apr. 5, 2007

(54) Compression of images for computer graphics

(75) Inventors: Kimmo Roimela, Tampere (FI); Tomi Aarnio, Tampere (FI); Joonas Itaranta, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/241,854

(22) Filed: Sep. 30, 2005

(51) Int. Cl. G06K 9/00

(52) U.S. Cl. 382/251

(57) ABSTRACT

A method for encoding an image having color components of each image pixel represented by a value of a high dynamic range (HDR), the method comprising: decomposing the image into image blocks; determining a scaling factor for each image block, said scaling factor, when applied to a corresponding image block, for converting the values of the color components into a normalized range; and compressing the normalized image blocks and the scaling factors of each image block independently of each other, whereby the normalized image blocks are encoded according to a low dynamic range (LDR) compression method. In a decoding phase, the encoded image data are decomposed into encoded image blocks, which are decoded according to the LDR compression method. The values of the color components are scaled with a corresponding scaling factor included in the auxiliary data; and the scaled image blocks are composed into an image with the original dynamic range.

### FIELD OF THE INVENTION

The present invention relates to computer graphics, and more particularly to compression of textures and other similar images used typically in three-dimensional computer graphics.

### BACKGROUND OF THE INVENTION

A commonly used technique in rendering a three-dimensional (3D) scene to have a more realistic look is to apply textures on the surfaces of 3D objects. A texture can be defined as an ordinary two-dimensional image, such as a photograph, that is stored in a memory as an array of pixels (or texels, to separate them from screen pixels). Along with the increase in the quality of displays and display drivers as well as in the processing power of graphics accelerators used in computers, the demand for even better image quality in computer graphics also continues. As a general rule, the more memory space and bandwidth can be spent on textures, the better the image quality can be achieved in the final 3D scene.

A traditional way of representing textures is to store the color of each pixel as a combination of three primary colors: red, green and blue (RGB). Typically 8 bits are allocated for each component, yielding 24 bits per pixel (24 bpp). This is called the RGB8 format. Other popular formats include RGB4 and RGB565 that sacrifice color gamut in favor of using less memory space. A problem with the traditional formats of representing colors is that they provide a rather limited dynamic range for colors, for example in comparison to a human's capability of simultaneously perceiving luminance across over 4 dB (i.e. a contrast ratio of 1:10⁴=1:10 000). Accordingly, textures created with these traditional methods are generally called low dynamic range (LDR) textures. The de facto standard in the field of LDR textures is DXTC (DirectX Texture Compression), also known as S3TC, which is further described in U.S. Pat. No. 6,658,146. Other similar methods include FXT, FLXTC, and ETC (Ericsson Texture Compression), the last one being disclosed also in WO05/059836.

In order to meet the demand for better image quality in computer graphics, image formats that are able to represent the entire dynamic range of luminance in the real world have been developed. These image formats are called high dynamic range (HDR) formats. The emerging de facto standard for storing and manipulating high dynamic range images is OpenEXR, which uses a 16-bit or a 32-bit floating-point representation for the color components. The dynamic range of OpenEXR is more than 11 dB when using the 16-bit variant and up to 76 dB when using the 32-bit variant. The 16-bit format is sufficient for most purposes, yielding a practical bit rate of 48 bpp.

A problem with the HDR textures is that they consume double the amount of memory and bus bandwidth compared to traditional LDR formats. Furthermore, very effective compressed formats exist for LDR textures that can bring the bit rate down to one sixth of the original. Thus, the difference between HDR and LDR textures, in terms of memory and bus bandwidth consumption, is a factor of 12 or more.

The OpenEXR standard supports several compression methods, like PIZ, ZIP, RLE and PXR24, but they all involve a technical shortcoming that none of them allow random access to the compressed data, which is absolutely crucial in mapping textures onto 3D objects. The graphics hardware needs to be able to decompress any given pixel in the image without having to decompress the entire image. Also the decompression must be very fast, since contemporary hardware can fetch and decompress billions of LDR texels per second, and any proposed HDR texture compression scheme should achieve performance that is at least close enough to that.

Ordinary image compression techniques applicable to HDR images as well, such as JPEG and PNG, are similar to the OpenEXR formats in that random access to individual pixels is not possible. In order to access a single pixel e.g. in a JPEG image, the entire image up to that pixel must be decompressed. This is obviously too slow, because millions or even billions of texels must be accessed per second in contemporary computer graphics, like in 3D games.

Accordingly, the conventional image compression techniques are useful in reducing the size of textures for permanent storage and transmission over a network, but they are poorly applicable for reducing the run-time memory space and bandwidth consumption in a decompressor.

### SUMMARY OF THE INVENTION

Now there is invented an improved method and technical equipment implementing the method, by which an efficient compression is achieved for HDR textures, while simultaneously allowing run-time per-pixel decompression in hardware. Various aspects of the invention include an encoding and a decoding method, an encoder, a decoder, an encoding system, an encoding/decoding apparatus and computer programs for performing the encoding and the decoding, which aspects are characterized by what is stated in the independent claims. Various embodiments of the invention are disclosed in the dependent claims.

According to a first aspect, a method according to the invention is based on the idea of encoding an image having color components of each image pixel represented by a value of a high dynamic range such that the image is first decomposed into a plurality of image blocks; a scaling factor is determined for each image block, said scaling factor, when applied to a corresponding image block, converting the values of the color components of the pixels in said image block into a normalized range; image data of the normalized image blocks are encoded according to a low dynamic range compression method; and finally the scaling factors of each image block are stored as a separate data.

According to an embodiment, the high dynamic range values of the color components of the pixels are represented with 16-bit or 32-bit floating point arithmetic.

According to an embodiment, the image data of the normalized image blocks are quantized with 8 bits per color component prior to encoding the image data.

According to an embodiment, the scaling factors are determined as power-of-two values; and only the powers of the scaling factors are stored in a separate file.

According to an embodiment, the powers of the scaling factors are quantized into a single-channel 8-bit texture image file prior to storing.

According to an embodiment, the low dynamic range compression method is DXTC compression.

According to an embodiment, the size of the image block is 4×4 pixels.

The encoding method according to the invention provides significant advantages. A major advantage is that significant memory savings, in view of both storage capacity and the required bus bandwidth, are achieved in handling of the HDR textures. For example, when compared to a non-compressed HDR texture using the 16-bit OpenEXR image format memory savings of over 90% can be achieved. Another significant advantage is that by the encoding method, an HDR image data is converted into a format compatible with and able to be decoded with a LDR decoding method. A further advantage is that embodiments can be implemented with only minor modifications to the existing hardware implementation.

According to a second aspect, there is provided a method for decoding an image from encoded image data comprising separate data units for image data encoded according to a low dynamic range compression method and for auxiliary data describing an original dynamic range of the image data, the method comprising: decomposing the encoded image data into a plurality of encoded image blocks; decoding the image blocks according to a method compatible with the low dynamic range compression method; scaling the values of the color components of the pixels of each decoded image block with a corresponding scaling factor included in the auxiliary data; and composing the scaled image blocks into an image with the original dynamic range.

According to an embodiment, the method is applied for random access decoding of any pixel of the encoded image data, whereby the method further comprises: identifying at least one pixel to be encoded; determining, after decomposing the encoded image data into the image blocks, an address of the at least one image block including the at least one pixel to be encoded; retrieving only the at least one image block including the at least one pixel for decoding; and retrieving only the scaling factor included in the auxiliary data which corresponds to said at least one image block for scaling the values of the color components of the pixels of said at least one image block.

The advantages provided by the decoding method according to the invention are apparent to any person of skill in the art. The decoding method enables the use of an LDR decompression method in order to output HDR image data. Nevertheless, the texturing hardware of the graphics subsystem advantageously interprets the decoded image data as if it had been read from a floating-point texture directly. The dynamic range, and consequently the image quality provided by the decoding method according to the invention is much better than in traditional LDR formats. Furthermore, the random access property according to an embodiment enables any pixels of any image block to be accessed randomly, whereby only needed sections of an image can beneficially be selected for decoding.

The further aspects of the invention include various apparatuses arranged to carry out the inventive steps of the above methods.

### BRIEF DESCRIPTION OF THE DRAWINGS

In the following, various embodiments of the invention will be described in more detail with reference to the appended drawings, in which

FIG. 1 shows an encoding/decoding apparatus according to an embodiment of the invention in a simplified block diagram;

FIG. 2 shows an image processing system according to an embodiment in a simplified block diagram;

FIG. 3 shows an image encoder system according to an embodiment in a simplified block diagram;

FIG. 4 shows an image decoder system according to an embodiment in a simplified block diagram;

FIG. 5 shows a random access subsystem of an image decoder according to an embodiment in a simplified block diagram; and

FIG. 6 shows a chart illustrating the operating principle of an encoding/decoding system according to an embodiment of the invention.

### DESCRIPTION OF EMBODIMENTS

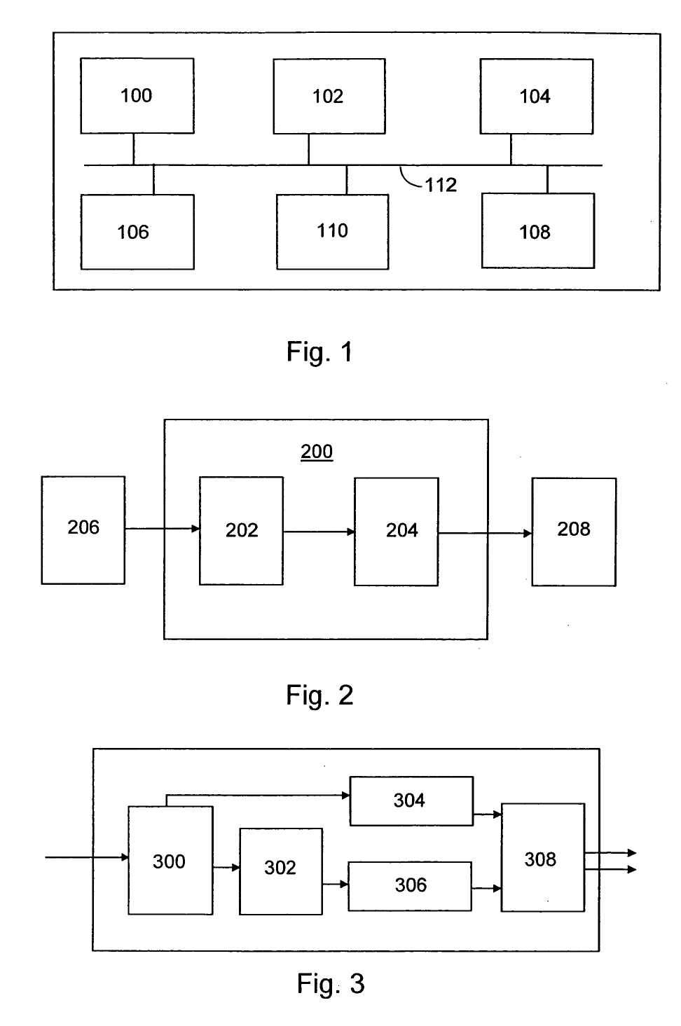

The structure of an encoding/decoding apparatus according to a preferred embodiment of the invention will now be explained with reference to FIG. 1. The structure will be explained with functional blocks of the encoding arrangement. For any person of skill in the art, it will be evident that several functionalities can be carried out with a single physical device, e.g. all calculation procedures can be performed in a single processor, if desired. A data processing system of an encoding/decoding apparatus according to an example of FIG. 1 includes a processing unit 100, a memory 102, a storage device 104, an input device 106, an output device 108, and a graphics subsystem 110, which all are connected to each other via a data bus 112.

The processing unit 100 is a conventional processing unit such as the Intel Pentium processor, Sun SPARC processor, or AMD Athlon processor, for example. The processing unit 100 processes data within the data processing system. The memory 102, the storage device 104, the input device 106, and the output device 108 are conventional components as recognized by those skilled in the art. The memory 102 and storage device 104 store data within the data processing system. The input device 106 inputs data into the system while the output device 108 receives data from the data processing system. The data bus 112 is a conventional data bus and while shown as a single line it may be a combination of a processor bus, a PCI bus, a graphical bus, and an ISA bus. Accordingly, any person of skill in the art will readily recognize that the encoding/decoding apparatus may be any conventional data processing device, like a computer device or a wireless terminal of a communication system, the device including an image encoder system and/or an image decoder system according to embodiments to described further below.

An image processing system 200 according to an embodiment is, further illustrated in a block diagram of FIG. 2. The image processing system 200 includes an image encoder system 202 and an image decoder system 204. The image encoder system 202 is coupled to receive an image from an image source 206. The image decoder system 204 is coupled to an output 208, to which processed images are forwarded for storage or further processing. The image processing system 200 may be run within the data processing system of FIG. 1, whereby the image encoder system 202 is coupled to the image decoder system 204 through a data line and may be coupled via a storage device 104 and/or a memory 102, for example. The image processing system 200 can also be distributed in separate units, a first unit including the image encoder system 202 and a transmitter for sending the encoded images via a communication channel, and a second unit including the image decoder system 204 and a receiver for receiving the encoded images.

Within the image encoder system 202, the image is broken down into individual blocks and processed before being forwarded to, e.g., the storage device 104, as compressed or encoded image data. When the encoded image data is ready for further data processing, the encoded image data is forwarded to the image decoder system 204. The image decoder system 204 receives the encoded image data and decodes it to generate an output that is a representation of the original image that was received from the image source 206.

An image encoder system 202 according to an embodiment is further illustrated in a block diagram of FIG. 3. The image encoder system 202 according to the embodiment preferably operates in many aspects similar to a known LDR image encoder system of the DXTC (DirectX Texture Compression). However, the image encoder systems designed for LDR textures are not capable of processing the high dynamic range provided by the 16-bit (or 32-bit) floating-point arithmetic of the HDR textures. Therefore, the known LDR image encoder system has to be redesigned in several aspects in order to carry out operations required by the embodiment. Accordingly, the image encoder system includes an image decomposer 300, a scaling unit 302, a header converter 304, one or more block encoders 306, and an encoded image composer 308.

For the processing of an HDR image, the image decomposer 300 is coupled to receive an original HDR image from a source, such as the image source 206. The image decomposer 300 forwards information from a header of the original HDR image to the header converter 304, which modifies the original header to generate a modified header. Then the image decomposer 300 breaks, or decomposes, the original HDR image into N number of image blocks IB_{N}, where N is some integer value. Preferably, the image is decomposed such that each image block is 4 pixels by 4 pixels (16 pixels). Any person of skill in the art appreciates that the number of pixels or the image block size may be varied, for example m*n pixels, where m and n are positive integer values.

These image blocks are fed into the scaling unit 302, wherein a maximum power-of-two scaling factor SF_{N} is determined for each block IB_{N} such that, when the scaling factor SF_{N} is applied to the HDR pixel values of the corresponding image block IB_{N}, the resulting pixel values will settle in the normalized range of [0, 1]. Computationally this is easy, since the floating-point arithmetic used by computer devices is based on power-of-two mathematics. Even though this straight-forward computation does not yield optimal normalization, since the highest scaled value may be less than 1.0, the dynamic range denotable by the scaling factor depends strongly on the power of the scaling factor. Accordingly, by storing only the power, a much larger dynamic range can be represented in the decoding phase.

Then the HDR pixel values in the first image block IB₁ are scaled with the scaling factor SF₁ of the first image block IB₁, the HDR pixel values in the second image block IB₂ are scaled with the scaling factor SF₂ of the second image block IB₂, etc. until the HDR pixel values of all image blocks IB_{N} have been scaled in the normalized range. Since the whole image has been scaled in the normalized range, it can be compressed according to a LDR compression method, like the DXTC. For that purpose, the normalized image data is quantized into a non-HDR texture with 8 bits per color channel. The normalized image can then be compressed using DXTC or other existing methods.

Meanwhile, the powers of the scaling factors are quantized into a single-channel 8-bit texture at 1/16th of the resolution of the original image (each power of a scaling factor representing an image block of 4×4 pixels, resulting in reduction into ¼ in both dimensions). However, the scaling factors cannot be compressed without introducing significant errors; therefore the DXTC compression is not applied to the texture including the powers of the scaling factors.

Accordingly, the normalized image blocks are input in the block encoders 306, whereby each block encoder 306 encodes or compresses each normalized image block to generate an encoded or compressed image block. In the DXTC compression, there are efficient compression algorithms available which enable a reduction of the original 24-bit RGB representation of each pixel into a 4-bit representation. For the details of the DXTC compression a reference is made to U.S. Pat. No. 6,658,146.

Even though frequent reference is made to the DXTC compression as an example of a LDR compression method, any person of skill in the art appreciates that the invention is by no means limited solely to the DXTC, but it can be applied to various LDR compression methods. An example of another applicable LDR texture compression scheme is the ETC, which is designed to be especially suitable for mobile applications. The bit allocation of the ETC is different from that of the DXTC, but also in the ETC, the image data is divided into image blocks, whereby a similar application of scaling factors, as described above, can be used with the ETC compression scheme.

The encoded image blocks are then inserted in the encoded image composer 308, which arranges the encoded blocks in a data file, which is concatenated with the modified header from the header converter 304 to generate an encoded image data file. The modified header generated by the header converter 304 includes information about file type, a number of bits per pixel of the original image, addressing into the original image, other miscellaneous encoding parameters, as well as the width and height information indicating the size of that original image. The modified header and the encoded image blocks together form the encoded image data that represents the original image, however in a low dynamic range (LDR) format. In order to enable the restoring of the image data into a high dynamic range (HDR) format in the decompression phase, the 1/16 resolution image of scaling factors is inserted in the encoded image composer 308, which then includes the non-compressed scaling factors in the image data file, however as a separate data unit. Alternatively, the texture of the non-compressed scaling factors can be stored and handled as a separate file. The separation of the encoded image data and the non-compressed scaling factors is indicated by the double arrows in the output of the image composer 308.

According to an embodiment, the scaling factors can be included in the data of their corresponding image blocks. Thus, the encoded blocks and their corresponding scaling factors can be inserted into the encoded image composer 308 sequentially, for example, such that the encoded image composer 308 first combines the first encoded image block and the scaling factor of the first encoded image block, then the second encoded image block and its scaling factor etc., and finally, when all the encoded image blocks have been combined with their scaling factors, the blocks are arranged into a data file. The scaling factors can be combined with the image block data e.g. by replacing some color information bits with bits representing the scaling factors in each image block such that the size of the image block is not affected.

The advantages provided by the embodiments are apparent to any person of skill in the art. A major advantage is that significant memory savings, in view of both storage capacity and the required bus bandwidth, are achieved in handling of the HDR textures. For example, a non-compressed HDR texture using the 16-bit OpenEXR image format has the practical bit rate of 48 bpp. The above-described procedure allows converting the bit rate into 4 bpp, and the 1/16 resolution image of scaling factors causes an additional minor overhead thereto. Nevertheless, in total the memory savings are over 90% compared to the 16-bit OpenEXR non-compressed HDR textures, and even greater memory savings are achieved, if the 32-bit OpenEXR image format is used. A further advantage is that embodiments can be implemented with only minor modifications to the existing hardware implementation.

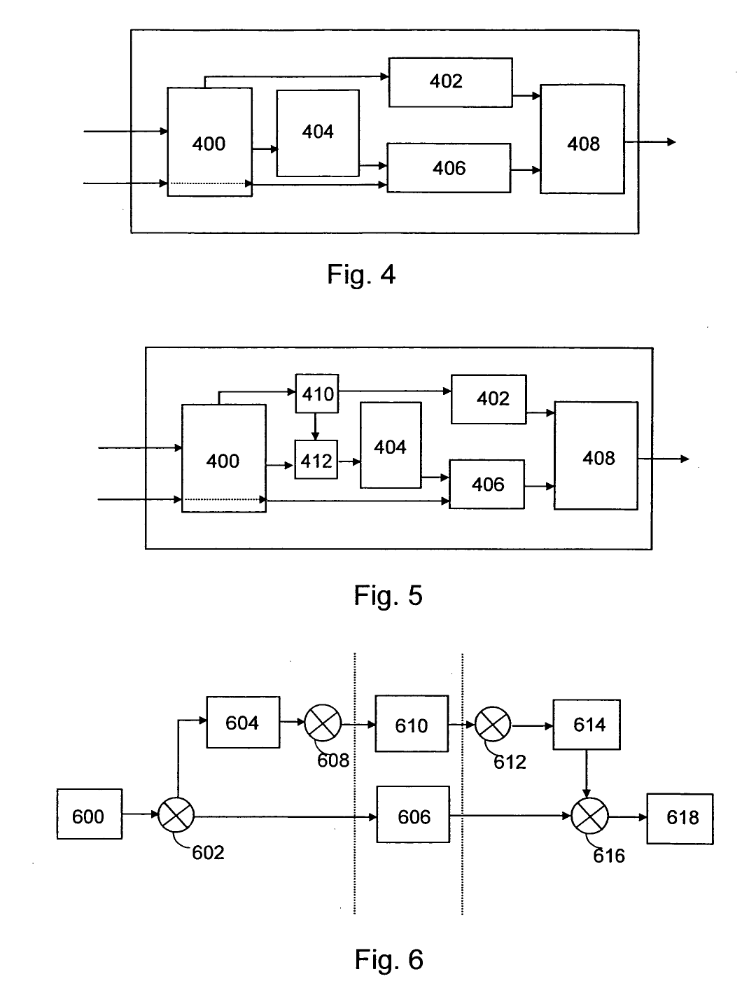

An image decoder system 204 according to an embodiment is further illustrated in the block diagram of FIG. 4. The image decoder system 204 includes an encoded image decomposing unit 400, a header converter 402, one or more block decoders 404, a scaling unit 406, and an image composer 408. The encoded image data and the non-compressed scaling factors are input to the decoder system as separated. The encoded image decomposer 400 is coupled to receive the encoded image data in the low dynamic range (LDR) format, which is output from the image encoder system 202. The encoded image decomposer 400 decomposes, or breaks, the encoded image data into its header and the encoded image blocks IB_{N}. The modified header is forwarded to the header converter 402. The individual encoded image blocks IB_{N} are forwarded to the one or more block decoders 404 for decompression. Simultaneously, the header converter 402 converts the modified header to an output header.

Until this stage, the structure and the operation of the image decoder system 204 corresponds to that of a known DXTC image decoder system. However, in order to restore the high dynamic range of the pixel data of the original image, the image decoder system 204 further includes the scaling unit 406 for applying the corresponding scaling factors SF_{N} for each of the decoded image blocks IB_{N}. Accordingly, the scaling unit 406 receives each decoded image block IB_{N} from the one or more block decoders 404 and fetches the corresponding scaling factors SF_{N} from the texture of the non-compressed scaling factors. Each of the power-of-two scaling factors SF_{N} is then combined with the normalized pixel values of the corresponding image block IB_{N}, which yields in floating-point pixel values of a high dynamic range for each image block IB_{N}. The decoded image blocks IB_{N} in the HDR format are then inserted in the image composer 408, which rearranges them in a file. Further, the image composer 408 receives the converted header from the header converter 402, which is placed together with the, decoded image blocks in order to generate output data representing the original HDR image data.

According to an embodiment, if the scaling factors have been included in the data of their corresponding image blocks as described above, the operation of the image decoder system has to be redesigned such that the block decoders 404 extract the scaling factors from the rest of the image block data. Then the decoded image blocks and their corresponding scaling factors are inserted into the scaling unit 406, e.g. sequentially, wherein each of the power-of-two scaling factors SF_{N} is combined with the normalized pixel values of the corresponding image block IB_{N}, and the output of the scaling unit 406 are the decoded image blocks IB_{N} in the HDR format.

The texturing hardware of the graphics subsystem advantageously interprets the image data as if it had been read from a floating-point texture directly. Any person of skill in the art will readily recognize that the scaling process described above causes some details from the original HDR image to be lost, but this happens in all lossy compression schemes. Moreover, due to the nature of the floating-point arithmetic used in HDR data, the large values usually dominate over small details in typical applications. In consequence, the loss of detail caused by the scaling process is not necessarily very apparent. Nevertheless, compared to traditional LDR formats, the dynamic range provided by the HDR image data according to the invention is enormously larger, enabling a far better quality of the decompressed image.

According to an embodiment, the image decoder system 204 further includes a subsystem that provides random access to any desired pixel or image block within an image. The random access subsystem, shown in FIG. 5, is implemented in the image decoder system of FIG. 4, and it includes a block address computation module 410, and a block fetching module 412, which is connected to the one or more block decoders 404. The block address computation module 410 receives header information of the encoded image data from the encoded image decomposer 400. The block fetching module 412 receives an encoded, image block portion of the encoded image data.

A process of random access to one or more pixels within an image typically starts by identifying the particular pixels to be decoded. When the image decoder system receives the encoded image data, the modified header of the encoded image data is forwarded to the block address computation module 410 and the encoded image block portion of the encoded image data is forwarded to the block fetching module 412. The block address computation module 410 deduces the address (i.e. the pixel coordinates) of the encoded image block portion including the desired pixels, and the block fetching module 412 identifies, based on the address, the encoded image block including the desired pixels. Then only the identified encoded image block is forwarded to the block decoders 404 for decoding. Again, the scaling unit 406 receives decoded image block IB_{N} from the block decoder 404 and the scaling factor SF_{N} corresponding to said image block IB_{N} is fetched from the texture of the non-compressed scaling factors. The quantized color levels computed by the block decoder 404 are then combined with the corresponding power-of-two scaling factor SF_{N}, whereby floating-point pixel values of a high dynamic range are achieved for each pixel of image block IB_{N}. Then the colors of the desired pixels are selected according to the pixel values and the desired pixels are output from the image decoder system.

According to an embodiment, the image decoder system includes a buffer memory, i.e. a texture cache, wherein the most frequently used encoded image blocks can be temporarily stored, and the random access and scaling process can be applied only to the desired pixels of the stored image blocks. In other words, the whole encoded image data does not need to be inserted into the decomposing unit 400, but only the desired encoded image blocks can be retrieved from the texture cache. The procedure is especially suitable for the ETC decompression scheme.

Consequently, since any pixels of any image block can be accessed randomly, only needed sections of an image can beneficially be selected for decoding. Random access also allows different sections of the image to be decoded in any desired order, which is preferable, for example, in three-dimensional texture mapping wherein only some portions of the texture may be required and these portions may further be required in some non-sequential order.

The operating principle of the embodiments described above can be further illustrated with the simplified block diagram of FIG. 6. An original HDR image 600 is processed in the image encoder system such that HDR image data is separated 602 into a non-HDR image data 604 and an HDR-related auxiliary data 606. The separation process 602 includes, as described earlier, decomposing the original HDR image into a header and a plurality of image blocks, determining scaling factors for each image block and scaling the image blocks such that image data based on 16/32-bit floating point arithmetic becomes compatible for a LDR image compression. Accordingly, the HDR-related auxiliary data 606 separated from the rest of the image data includes the powers of the scaling factors. The non-HDR image data 604 is exposed to a LDR image compression 608, as a result of which an encoded image data file 610 in a LDR format is generated.

The image data files 600 and 604 and the processing steps 602 and 608 belong to the image encoding phase or image pre-processing phase, which is separated in FIG. 6 from the rest of the steps with a dashed line for the sake of illustration. The outcome of the processing steps, i.e. the encoded image data file 610 in a LDR format and the HDR-related scaling factor data 606 represent an intermediate data of the image processing system, which data is stored at least temporarily in a memory storage, wherefrom it can be retrieved for run-time execution. The memory storage phase is separated in FIG. 6 from the run-time execution phase with another dashed line.

In the run-time execution, the encoded image data file 610 in a LDR format is decompressed according to a LDR image decompression process 612. The outcome of the decompression process 612 is an image file 614 with normalized RGBA pixel values. The normalized RGBA pixel values are scaled 616 with the corresponding HDR-related scaling factor data 606, resulting in reconstructed output data 618 representing the original HDR image data 600.

The steps according to the embodiments can be largely implemented with program commands to be executed in the processing unit of a data processing device operating as an encoding and/or decoding apparatus. Thus, said means for carrying out the method described above can be implemented as computer software code, even though a hardware solution at least in the decoder may be more preferable. The computer software may be stored into any memory means, such as the hard disk of a PC or a CD-ROM disc, from where it can be loaded into the memory of the data processing device. The computer software can also be loaded through a network, for instance using a TCP/IP protocol stack. It is also possible to use a combination of hardware and software solutions for implementing the inventive means.

It should be evident to those of skill in the art that the present invention is not limited solely to the above-presented embodiments, but it can be modified within the scope of the appended claims. For instance, although specific examples of encoding/decoding techniques with both high and low dynamic ranges have been described, the invention is not limited thereto. It is enough for purposes of the present invention that a first encoding/decoding technique utilizing components having values that vary over a high dynamic range have such values varying over a dynamic range that is greater than that of a second encoding/decoding technique.

1. A method for encoding an image of pixels having color components represented by values of high dynamic range, the method comprising:
decomposing the image into a plurality of image blocks;
determining a scaling factor for each image block, said scaling factor, when applied to a corresponding image block, converting the values of the color components of the pixels in said image block into a normalized range; and
compressing image data of normalized image blocks and scaling factors of each image block independently of each other, whereby the image data of the normalized image blocks is encoded according to a low dynamic range compression method.

2. The method according to claim 1, the method further comprising:
storing the scaling factors of each image block as a separate data.

3. The method according to claim 1, the method further comprising:
storing the scaling factors of each image block in data of a corresponding encoded image block.

4. The method according to claim 1, the method further comprising:
representing high dynamic range values of the color components with 16-bit or 32-bit floating point arithmetic.

5. The method according to claim 1, the method further comprising:
quantizing the image data of the normalized image blocks with 8 bits per color component prior to encoding the image data.

6. The method according to claim 1, the method further comprising:
determining the scaling factors as power-of-two values; and
storing only powers of the scaling factors in a separate file.

7. The method according to claim 6, the method further comprising:
quantizing the powers of the scaling factors into a single-channel 8-bit texture image file prior to storing.

8. The method according to claim 1, wherein the low dynamic range compression method is DXTC compression or ETC compression.

9. The method according to claim 1, wherein the image blocks are 4×4 pixels in size.

10. A method for decoding an image from encoded image data comprising independently compressed image data and auxiliary data, wherein the image data is encoded according to a low dynamic range compression method and the auxiliary data describes an original dynamic range of the image data, the method comprising:
decomposing the encoded image data into a plurality of encoded image blocks;
decoding the image blocks according to a method compatible with the low dynamic range compression method;
scaling values of color components of pixels of each decoded image block with a corresponding scaling factor included in the auxiliary data; and
composing scaled image blocks into an image with the original dynamic range.

11. The method according to claim 10, the method further comprising:
representing original dynamic range values of the color components of the pixels with 16-bit or 32-bit floating point arithmetic.

12. The method according to claim 10, wherein:
scaling factors are determined as power-of-two values; and
only powers of the scaling factors are included in the auxiliary data.

13. The method according to claim 10, wherein the low dynamic range compression method is DXTC compression or ETC compression.

14. The method according to claim 10, for decoding any pixel of the encoded image data, the method further comprising:
identifying at least one pixel to be decoded;
determining, after decomposing the encoded image data into the image blocks, an address of the at least one image block including the at least one pixel to be decoded;
retrieving only the at least one image block including the at least one pixel for decoding; and
retrieving only the scaling factor included in the auxiliary data which corresponds to said at least one image block for scaling the values of the color components of the pixels of said at least one image block.

15. An image encoder comprising:
an image decomposer for receiving an image of pixels having color components represented by values of high dynamic range and for decomposing the image into a plurality of image blocks;
a scaling means for determining a scaling factor for each image block, said scaling factor, when applied to a corresponding image block, converting the values of the color components of the pixels in said image block into a normalized range;
at least one block encoder for encoding image data of normalized image blocks according to a low dynamic range compression method; and
an encoded image composer for composing an encoded image file comprising the low dynamic range image data and scaling factors of each image block compressed independently of each other.

16. The image encoder according to claim 15, wherein
the scaling factors of each image block are stored as a separate data.

17. The image encoder according to claim 15, wherein
the scaling factors of each image block are stored in the data of the corresponding encoded image block.

18. The image encoder according to claim 15, wherein
high dynamic range values of the color components are represented with 16-bit or 32-bit floating point arithmetic.

19. The image encoder according to claim 15, further comprising:
means for quantizing the image data of the normalized image blocks with 8 bits per color component prior to encoding the image data.

20. The image encoder according to claim 15, wherein
the scaling means are arranged to determine the scaling factors as power-of-two values; and
only powers of the scaling factors are arranged to be stored in a separate file.

21. The image encoder according to claim 20, further comprising:
means for quantizing the powers of the scaling factors into a single-channel 8-bit texture image file prior to storing.

22. An image decoder comprising:
an image decomposer for receiving an encoded image comprising independently compressed image data and auxiliary data, wherein the image data is encoded according to a low dynamic range compression method and the auxiliary data describes an original dynamic range of the image data and for decomposing encoded image data into a plurality of encoded image blocks;
at least one block decoder for decoding the image blocks according to a method compatible with the low dynamic range compression method;
a scaling means for scaling values of the color components of pixels of each decoded image block with a corresponding scaling factor included in the auxiliary data; and
an image composer for composing scaled image blocks into an image with the original dynamic range.

23. The image decoder according to claim 22, further comprising:
means for representing original dynamic range values of color components of the pixels with 16-bit or 32-bit floating point arithmetic.

24. The image decoder according to claim 23, wherein:
scaling factors are determined as power-of-two values; and
only powers of the scaling factors are included in the auxiliary data.

25. The image decoder according to claim 22, further comprising:
means for identifying at least one pixel to be decoded;
a block address computation means for determining, after decomposing the encoded image data into the image blocks, an address of the at least one image block including the at least one pixel to be decoded;
a block fetching means for retrieving only the at least one image block including the at least one pixel for decoding; and
means for retrieving only the scaling factor included in the auxiliary data which corresponds to said at least one image block for scaling the values of the color components of the pixels of said at least one image block.

26. An image processing device for encoding an image having pixels with color components represented by values of high dynamic range, the device including an image encoder comprising:
an image decomposer for receiving said image and for decomposing the image into a plurality of image blocks;
a scaling means for determining a scaling factor for each image block, said scaling factor, when applied to a corresponding image block, converting the values of the color components of the pixels in said image block into a normalized range;
at least one block encoder for encoding image data of normalized image blocks according to a low dynamic range compression method; and
an encoded image composer for composing an encoded image file comprising low dynamic range image data and the scaling factors of each image block compressed independently of each other.

27. An image processing device for decoding an encoded image comprising independently compressed image data and auxiliary data, wherein the image data is encoded according to a low dynamic range compression method and the auxiliary data describes an original dynamic range of the image data, the device including an image decoder comprising:
an image decomposer for receiving said encoded image and for decomposing encoded image data into a plurality of encoded image blocks;
at least one block decoder for decoding the image blocks according to a method compatible with the low dynamic range compression method;
a scaling means for scaling values of color components of pixels of each decoded image block with a corresponding scaling factor included in the auxiliary data; and
an image composer for composing scaled image blocks into an image with the original dynamic range.

28. A computer program product, stored on a computer readable medium and executable in a data processing device, for encoding an image having pixels with color components represented by values of high dynamic range, the computer program product comprising:
a computer program code section for receiving said image and for decomposing the image into a plurality of image blocks;
a computer program code section for determining a scaling factor for each image block, said scaling factor, when applied to a corresponding image block, for converting values of the color components of the pixels in said image block into a normalized range;
a computer program code section for encoding image data of normalized image blocks according to a low dynamic range compression method; and
a computer program code section for composing an encoded image file comprising low dynamic range image data and scaling factors of each image block compressed independently of each other.

29. A computer program product, stored on a computer readable medium and executable in a data processing device, for decoding an encoded image comprising independently compressed image data and auxiliary data, wherein the image data is encoded according to a low dynamic range compression method and the auxiliary data describes an original dynamic range of the image data, the computer program product comprising:
a computer program code section for receiving said encoded image and for decomposing the encoded image data into a plurality of encoded image blocks;
a computer program code section for decoding the image blocks according to a method compatible with the low dynamic range compression method;
a computer program code section for scaling values of color components of pixels of each decoded image block with a corresponding scaling factor included in the auxiliary data; and
a computer program code section for composing scaled image blocks into an image with the original dynamic range.
